(19) United States
(12) Patent Application Publication
(10) Pub. No.: US 2022/0176922 A1
(43) Pub. Date: Jun. 9, 2022

(54) DRIVING ASSISTANCE SYSTEM

(71) Applicant: TOYOTA JIDOSHA KABUSHIKI KAISHA, Toyota-shi (JP)

(72) Inventor: Kumiko KONDO, Numazu-shi (JP)

(73) Assignee: TOYOTA JIDOSHA KABUSHIKI KAISHA, Toyota-shi (JP)

(21) Appl. No.: 17/489,283

(22) Filed: Sep. 29, 2021

(30) Foreign Application Priority Data
Dec. 9, 2020 (JP) 2020-204424

(51) Int. Cl. B60T 8/171; B60T 7/12

(52) U.S. Cl. CPC B60T 8/171; B60T 2210/32; B60T 7/12

(57) ABSTRACT

A driving assistance system that executes deceleration assistance of a vehicle when a relative state between the vehicle and a deceleration object ahead satisfies a preset condition includes a brake operation detection unit configured to detect whether a brake operation is performed by a driver of the vehicle during the deceleration assistance, a deceleration gradient setting unit configured to, when a brake operation is performed by the driver during the assistance, set a deceleration gradient to stop the assistance based on at least one of presence or absence of a forward obstacle ahead, a relative state between the vehicle and the forward obstacle, and a road environment in which the vehicle travels, and a deceleration assistance stop unit configured to, when a brake operation is performed by the driver during the assistance, stop the assistance of the vehicle along the deceleration gradient set by the deceleration gradient setting unit.

### CROSS-REFERENCE TO RELATED APPLICATION

This application claims priority to Japanese Patent Application No. 2020-204424 filed on Dec. 9, 2020, incorporated herein by reference in its entirety.

### BACKGROUND

### 1. Technical Field

The disclosure relates to a driving assistance system.

### 2. Description of Related Art

Hitherto, Japanese Unexamined Patent Application Publication No. 2019-028754 (JP 2019-028754 A) is known as a technical document relating to a driving assistance system. JP 2019-028754 A describes that, when a driver performs a brake operation while deceleration assistance is executed for a deceleration object (predetermined object), a vehicle is decelerated at a deceleration that is the sum of a deceleration required from the brake operation of the driver and a deceleration based on the deceleration assistance.

### SUMMARY

Incidentally, after the driver performs a brake operation during deceleration assistance, if the deceleration assistance is suddenly stopped when a deceleration object disappears or deceleration assistance is stopped without consideration of the state of a host vehicle, the driver may feel a sense of discomfort.

An aspect of the disclosure relates to a driving assistance system. The driving assistance system executes deceleration assistance of a host vehicle when a relative state between the host vehicle and a deceleration object ahead of the host vehicle satisfies a preset deceleration assistance start condition. The driving assistance system includes a brake operation detection unit, a deceleration gradient setting unit, and a deceleration assistance stop unit. The brake operation detection unit is configured to detect whether a brake operation is performed by a driver of the host vehicle during the deceleration assistance. The deceleration gradient setting unit is configured to, when a brake operation is performed by the driver during the deceleration assistance, set a deceleration gradient to stop the deceleration assistance based on at least one of presence or absence of a forward obstacle ahead of the host vehicle, a relative state between the host vehicle and the forward obstacle, and a road environment in which the host vehicle travels. The deceleration assistance stop unit is configured to, when a brake operation is performed by the driver during the deceleration assistance, stop the deceleration assistance of the host vehicle along the deceleration gradient set by the deceleration gradient setting unit.

With the driving assistance system according to the aspect of the disclosure, when a brake operation is performed by the driver during the deceleration assistance, a deceleration gradient to stop the deceleration assistance is set based on at least one of presence or absence of a forward obstacle ahead of the host vehicle, a relative state between the host vehicle and the forward obstacle, and a road environment in which the host vehicle travels, and the deceleration assistance of the host vehicle is stopped along the set deceleration gradient. Therefore, in comparison with an existing system that stops deceleration assistance without consideration of a forward obstacle or a road environment, a sense of discomfort experienced by the driver is reduced.

In the driving assistance system according to the aspect of the disclosure, the deceleration gradient setting unit may be configured to, when the forward obstacle is not present at the time of the brake operation, set the deceleration gradient to a steeper gradient as compared to when the forward obstacle is present at the time of the brake operation. With this driving assistance system, when the forward obstacle is not present at the time of the brake operation, the deceleration gradient is set to a steeper gradient as compared to when the forward obstacle is present at the time of the brake operation. Therefore, in comparison with the case where the deceleration is reduced by a gentle gradient although the forward obstacle is not present, a sense of discomfort experienced by the driver is reduced.

In the driving assistance system according to the aspect of the disclosure, the deceleration gradient setting unit may be configured to, when the forward obstacle is present at the time of the brake operation, set the deceleration gradient to a gentler gradient as a distance between the host vehicle and the forward obstacle becomes shorter or a time to collision of the host vehicle to the forward obstacle becomes shorter. With this driving assistance system, the deceleration gradient is set to a gentler gradient as a distance between the host vehicle and the forward obstacle becomes shorter or as a time to collision of the host vehicle to the forward obstacle becomes shorter. Therefore, in comparison with the case where the deceleration gradient is constant regardless of a distance or time to collision between the host vehicle and the forward obstacle, a sense of discomfort experienced by the driver is reduced.

In the driving assistance system according to the aspect of the disclosure, the deceleration gradient setting unit may be configured to, when the road environment in which the host vehicle travels is an uphill, set the deceleration gradient to a steeper gradient as compared to when the road environment in which the host vehicle travels is a downhill. With this driving assistance system, when the road environment in which the host vehicle travels is an uphill, the deceleration gradient is set to a steeper gradient as compared to when the road environment is a downhill. Therefore, in comparison with the case where the deceleration gradient is the same between an uphill and a downhill, a sense of discomfort experienced by the driver is reduced.

In the driving assistance system according to the aspect of the disclosure, the deceleration gradient setting unit may be configured to, when the road environment in which the host vehicle travels is a curve, set the deceleration gradient to a gentler gradient as compared to when the road environment in which the host vehicle travels is a straight road. With this driving assistance system, when the road environment in which the host vehicle travels is a curve, the deceleration gradient is set to a gentler gradient as compared to when the road environment is a straight road. Therefore, a sudden change in vehicle deceleration while the vehicle is traveling on a curve is reduced, which contributes to running stability.

According to the aspect of the disclosure, in stopping deceleration assistance, a sense of discomfort experienced by a driver is reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a driving assistance system according to an embodiment;

FIG. 2A is a graph showing an example of a change in deceleration gradient according to presence or absence of a forward obstacle;

FIG. 2B is a graph showing an example of a change in deceleration gradient according to a road environment in which a host vehicle travels;

FIG. 3 is a graph showing an example of a change in the deceleration of the vehicle when a brake operation of a driver is continued in stopping deceleration assistance;

FIG. 4 is a flowchart showing an example of a deceleration assistance start process;

FIG. 5A is a flowchart showing an example of a deceleration assistance stop process;

FIG. 5B is a flowchart showing an example of a deceleration gradient setting process;

FIG. 6 is a flowchart showing another example of a deceleration gradient setting process; and

FIG. 7 is a flowchart showing further another example of a deceleration gradient setting process.

### DETAILED DESCRIPTION OF EMBODIMENTS

Hereinafter, an embodiment of the disclosure will be described with reference to the accompanying drawings.

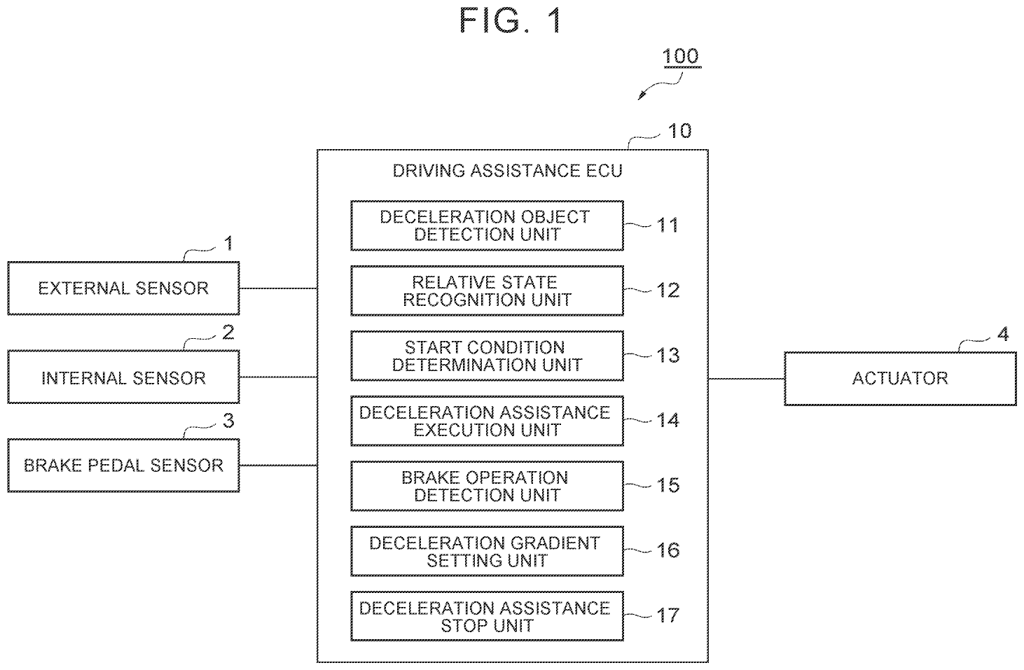

As shown in FIG. 1, a driving assistance system 100 is installed in a vehicle (host vehicle), such as a passenger vehicle, and assists a driver in driving the host vehicle. The driving assistance system 100 executes deceleration assistance of the host vehicle under a predetermined condition when the driving assistance system 100 detects a deceleration object, such as a preceding vehicle and a traffic light, ahead of the host vehicle. Deceleration objects are objects that cause deceleration assistance. Deceleration objects include another vehicle. Deceleration objects may include a pedestrian and a bicycle in addition to another vehicle. Deceleration objects may include a traffic light, a stop line, a curve, a crosswalk, a fallen object, a construction setup, and a structure.

Deceleration assistance is driving assistance that causes the host vehicle to decelerate to a preset target vehicle speed. The target vehicle speed is not limited and may be 0 km/h or may be 10 km/h. The target vehicle speed may be determined according to the type of a deceleration object. When the deceleration object is a traffic light, the target vehicle speed of deceleration assistance may be changed according to the status of the traffic light (status such as green light, yellow light, and red light). When the deceleration object is a moving object, such as a preceding vehicle, the target vehicle speed is not limited to the speed of the host vehicle and may be a relative speed between the host vehicle and the deceleration object. Deceleration assistance may be configured not to be executed according to a target vehicle speed and may be configured to be executed along a target deceleration pattern that is a time change in target deceleration.

### Configuration of Driving Assistance System

Hereinafter, the configuration of the driving assistance system 100 will be described with reference to the accompanying drawings. As shown in FIG. 1, the driving assistance system 100 includes a driving assistance electronic control unit (ECU) 10 that generally manages the system. The driving assistance ECU 10 is an electronic control unit including a central processing unit (CPU), a read-only memory (ROM), a random access memory (RAM), and the like. In the driving assistance ECU 10, for example, various functions are implemented by the CPU running programs stored in the ROM. The driving assistance ECU 10 may be made up of a plurality of electronic control units.

The driving assistance ECU 10 is connected to an external sensor 1, an internal sensor 2, a brake pedal sensor 3, and an actuator 4.

The external sensor 1 is a detector that detects a situation around the host vehicle. The external sensor 1 includes at least one of a camera and a radar sensor. The camera is an imaging device that captures the image of a situation outside the host vehicle. The camera is provided on, for example, the back side of a windshield of the host vehicle and captures an image ahead of the host vehicle. The camera transmits captured image information on the situation outside the host vehicle to the driving assistance ECU 10. The camera may be a monocular camera or a stereo camera.

The radar sensor is a detector that detects an object around the host vehicle by using radio waves (for example, millimeter waves) or light. Examples of the radar sensor include millimeter-wave radar and light detection and ranging (LIDAR). The radar sensor transmits radio waves or light to an area around the host vehicle and receives radio waves or light reflected from an object. Thus, the radar sensor detects the object. The radar sensor transmits detected object information to the driving assistance ECU 10.

The internal sensor 2 is a detector that detects the running status of the host vehicle. The internal sensor 2 includes a vehicle speed sensor, an acceleration sensor, and a yaw rate sensor. The vehicle speed sensor is a detector that detects the speed of the host vehicle. The vehicle speed sensor is, for example, a wheel speed sensor. The wheel speed sensor is provided on each wheel of the host vehicle or a drive shaft or the like that rotates integrally with each wheel, and detects the rotation speed of the wheel. The vehicle speed sensor transmits detected vehicle speed information (wheel speed information) to the driving assistance ECU 10.

The acceleration sensor is a detector that detects the acceleration of the host vehicle. The acceleration sensor includes, for example, a longitudinal acceleration sensor and a lateral acceleration sensor. The longitudinal acceleration sensor detects the acceleration of the host vehicle in a front and rear direction. The lateral acceleration sensor detects the lateral acceleration of the host vehicle. The acceleration sensor transmits, for example, information on the acceleration of the host vehicle to the driving assistance ECU 10. The yaw rate sensor is a detector that detects a yaw rate (rotation angular velocity) about the vertical axis at the center of gravity of the host vehicle. The yaw rate sensor may be, for example, a gyro sensor. The yaw rate sensor transmits information on the detected yaw rate of the host vehicle to the driving assistance ECU 10.

The brake pedal sensor 3 is, for example, provided on a shaft portion of a brake pedal of the host vehicle and detects the depression amount of the brake pedal. The brake pedal sensor 3 transmits a brake operation signal corresponding to the detected depression amount of the brake pedal to the driving assistance ECU 10.

The actuator 4 is a device that is used to control the host vehicle. The actuator 4 includes at least a drive actuator and a brake actuator. The actuator 4 may include a steering actuator. The drive actuator controls the amount of air supplied to an engine (throttle opening degree) in response to a control signal from the driving assistance ECU 10 and controls the driving force of the host vehicle. When the host vehicle is a hybrid vehicle, a control signal from the driving assistance ECU 10 is input to a motor that serves as a power source and the driving force is controlled, in addition to control over the amount of air supplied to the engine. When the host vehicle is an electric vehicle, a control signal from the driving assistance ECU 10 is input to a motor that serves as a power source, and the driving force is controlled. The motor that serves as a power source in these cases is a component of the actuator 4.

The brake actuator controls a brake system in response to a control signal from the driving assistance ECU 10 and controls braking force to be applied to the wheels of the host vehicle. The brake system may be, for example, a hydraulic brake system. The steering actuator controls an assist motor within an electric power steering system in response to a control signal from the driving assistance ECU 10. The assist motor controls steering torque. Thus, the steering actuator controls the steering torque of the host vehicle.

Next, the functional configuration of the driving assistance ECU 10 will be described. As shown in FIG. 1, the driving assistance ECU 10 includes a deceleration object detection unit 11, a relative state recognition unit 12, a start condition determination unit 13, a deceleration assistance execution unit 14, a brake operation detection unit 15, a deceleration gradient setting unit 16, and a deceleration assistance stop unit 17. One or some of the functions of the driving assistance ECU 10, which will be described below, may be executed on a server that communicates with the host vehicle.

The deceleration object detection unit 11 detects a deceleration object, such as a preceding vehicle, ahead of the host vehicle based on information detected by the external sensor 1. The deceleration object detection unit 11 detects a deceleration object ahead of the host vehicle based on an image captured by the camera or object information detected by the radar sensor.

The deceleration object detection unit 11 detects a deceleration object, such as a traffic light, a stop line, and a preceding vehicle, by, for example, performing pattern matching using a prestored image pattern for each type of deceleration object based on an image ahead of the host vehicle, captured by the camera. When the deceleration object is a traffic light, the deceleration object detection unit 11 determines the status of the traffic light with a known image processing technology. The deceleration object detection unit 11 may determine a type of deceleration object based on object information from the radar sensor.

The relative state recognition unit 12 recognizes a relative state between the host vehicle and a deceleration object. The relative state includes at least a distance between the host vehicle and a deceleration object (a distance in the front and rear direction or the traveling direction of the host vehicle). The relative state may include a relative speed between the host vehicle and a deceleration object, may include a time to collision (TTC) of the host vehicle to a deceleration object, and may include a time headway (THW).

The relative state recognition unit 12 recognizes a relative state between the host vehicle and a deceleration object based on, for example, information detected by the external sensor 1. When the deceleration object is a vehicle capable of performing inter-vehicle communication with the host vehicle, the relative state recognition unit 12 may recognize a relative state between the host vehicle and the deceleration object by using information acquired through inter-vehicle communication. The relative state recognition unit 12 may recognize a relative speed between the host vehicle and a deceleration object based on, for example, the speed of the deceleration object, acquired through inter-vehicle communication, and the speed of the host vehicle. The relative state recognition unit 12 may use information detected by the internal sensor 2 (information detected by the vehicle speed sensor) to recognize a relative speed between the host vehicle and a deceleration object.

The start condition determination unit 13 determines whether a deceleration assistance start condition for a deceleration object is satisfied. The deceleration assistance start condition is a condition set in advance to be used in determining whether to start deceleration assistance. The start condition determination unit 13 determines whether the deceleration assistance start condition is satisfied based on at least a distance between the host vehicle and a deceleration object.

The deceleration assistance start condition may be changed according to the type of a deceleration object. For example, when the type of a deceleration object is a preceding vehicle, the start condition determination unit 13 determines whether the deceleration assistance start condition for the preceding vehicle is satisfied, based on a relative state between the host vehicle and the deceleration object.

Specifically, the start condition determination unit 13 determines that the deceleration assistance start condition for a preceding vehicle is satisfied when the speed of the host vehicle is higher than the speed of the preceding vehicle (the relative speed is positive in an approaching direction) and a time to collision between the host vehicle and the preceding vehicle is shorter than a time to collision threshold. A time to collision is obtained by dividing a distance between the host vehicle and the deceleration object (preceding vehicle) by a relative speed (approaching speed) between the host vehicle and the deceleration object. The time to collision threshold is a threshold value set in advance. Hereinafter, thresholds used in the description mean threshold values set in advance.

The start condition determination unit 13 may determine that the deceleration assistance start condition for a preceding vehicle is satisfied when, instead of a time to collision, a time headway obtained by dividing a distance between the host vehicle and the preceding vehicle by the speed of the host vehicle becomes shorter than a headway time threshold. The start condition determination unit 13 may determine that the deceleration assistance start condition for a preceding vehicle is satisfied when, instead of a time to collision, a distance between the host vehicle and the preceding vehicle is shorter than a distance threshold.

The start condition determination unit 13 may determine that the deceleration assistance start condition for a preceding vehicle is satisfied when the speed of the host vehicle is higher than the speed of the preceding vehicle and a required deceleration of the host vehicle is higher than or equal to a deceleration threshold. A required deceleration may be, for example, a deceleration required to avoid a situation in which a distance between the host vehicle and a preceding vehicle becomes shorter than a threshold set in advance for each speed. A required deceleration may be a deceleration required to avoid a situation in which a distance between the host vehicle and a preceding vehicle becomes shorter than a certain value.

When the type of a deceleration object is a stop line, the start condition determination unit 13 may determine whether a deceleration assistance start condition for the stop line is satisfied, based on the speed of the host vehicle, detected by the internal sensor 2 (vehicle speed sensor), and a relative state between the host vehicle and the stop line.

Specifically, the start condition determination unit 13 may determine that the deceleration assistance start condition for the stop line is satisfied when the speed of the host vehicle is higher than or equal to an assistance start speed threshold and a time to collision between the host vehicle and the stop line is shorter than a time to collision threshold. A time to collision in this case corresponds to a time of arrival of the host vehicle to the stop line. The start condition determination unit 13 may determine that the deceleration assistance start condition for a stop line is satisfied when, instead of a time to collision, a distance between the host vehicle and the stop line is shorter than a distance threshold.

The start condition determination unit 13 may determine that the deceleration assistance start condition for a stop line is satisfied when the speed of the host vehicle is higher than or equal to an assistance start speed threshold and a required deceleration of the host vehicle is higher than or equal to a deceleration threshold. A required deceleration in this case is, for example, a deceleration required for the host vehicle to stop at the location of a stop line. A time to collision threshold, a distance threshold, and a deceleration threshold each may be a value that varies according to the type of a deceleration object.

When the type of a deceleration object is a traffic light, the start condition determination unit 13 may evaluate the deceleration assistance start condition by using a stop line just before the traffic light as an object. When the type of a deceleration object is a traffic light and a stop line just before the traffic light is not detected by the external sensor 1 because of abrasion or the like of a white line corresponding to the stop line, the start condition determination unit 13 evaluates the deceleration assistance start condition on the assumption that the stop line is present a certain distance before the traffic light.

When the type of a deceleration object is a traffic light, the start condition determination unit 13 may determine whether the deceleration assistance start condition is satisfied, based on the status of the traffic light at the time when the host vehicle approaches the traffic light. The time when the host vehicle approaches a traffic light is, for example, the time when a time to collision of the host vehicle to the location of a stop line just before the traffic light or a location set at a certain distance before the traffic light becomes shorter than a time to collision threshold. Instead of a time to collision, a time headway may be used, or a distance between the host vehicle and a stop line (or a location set at a certain distance before a traffic light) may be used.

When the host vehicle approaches a traffic light, the start condition determination unit 13 determines whether the traffic light is in a pass permission state, based on information detected by the external sensor 1 (for example, an image captured by the camera). Here, a pass permission state means a state of giving permission to pass in the direction of traffic of a driving lane of the host vehicle. The direction of traffic of a driving lane of the host vehicle can be recognized through image recognition of an arrow sign on a road in the driving lane (an arrow sign painted on a road), image recognition of a sign indicating the direction of traffic of the driving lane, or the like. The direction of traffic of a driving lane of the host vehicle may be recognized from the location of the host vehicle and map information (map information containing information on the traveling direction of each lane).

When the start condition determination unit 13 determines that the traffic light is not in a pass permission state (when the traffic light is in a pass prohibition state or a transition state), the start condition determination unit 13 determines that the deceleration assistance start condition is satisfied.

When the start condition determination unit 13 determines that the traffic light is in the pass permission state, the start condition determination unit 13 determines whether the host vehicle turns right or left or not. The start condition determination unit 13 determines whether the host vehicle turns right or left, based on, for example, the direction of traffic of the driving lane of the host vehicle. When the driving lane is a right-turn lane or a left-turn lane, the start condition determination unit 13 determines that the host vehicle turns right or left. The start condition determination unit 13 may determine whether the host vehicle turns right or left or not, based on the status of direction indicators of the host vehicle.

When the start condition determination unit 13 determines that the traffic light is in the pass permission state and the host vehicle turns right or left, the start condition determination unit 13 determines that the deceleration assistance start condition is satisfied. When the start condition determination unit 13 determines that the traffic light is in the pass permission state and the host vehicle does not turn right or left (goes straight ahead), the start condition determination unit 13 determines that the deceleration assistance start condition is not satisfied.

When the start condition determination unit 13 determines that the deceleration assistance start condition is satisfied, the deceleration assistance execution unit 14 executes deceleration assistance. Deceleration assistance is control to assist the host vehicle in decelerating relative to a deceleration object. Deceleration assistance is executed by controlling the brake actuator such that, for example, the deceleration of the host vehicle becomes a target deceleration preset according to, for example, a relative state (distance, relative speed, time to collision, or the like) between the host vehicle and a deceleration object. Deceleration assistance may be executed such that the deceleration is fixed.

When the start condition determination unit 13 determines that the deceleration assistance start condition is satisfied, the deceleration assistance execution unit 14 executes deceleration assistance by transmitting a control signal to the actuator 4. The deceleration assistance execution unit 14 executes deceleration assistance through, for example, engine braking control with the drive actuator and/or braking force control with the brake actuator.

The deceleration assistance execution unit 14 may be configured not to start deceleration assistance while a brake operation is being performed by the driver even when the deceleration assistance start condition is satisfied or may be configured not to start deceleration assistance while an accelerator operation is being performed by the driver even when the deceleration assistance start condition is satisfied.

The brake operation detection unit 15 detects a brake operation of the driver during execution of deceleration assistance. The brake operation detection unit 15 detects a brake operation of the driver based on information detected by the brake pedal sensor 3. The brake operation detection unit 15 detects a brake operation of the driver when, for example, the depression amount of the brake pedal of the driver, detected by the brake pedal sensor 3, is greater than or equal to a brake operation threshold.

The deceleration gradient setting unit 16 sets a deceleration gradient used to stop deceleration assistance when a brake operation of the driver is detected by the brake operation detection unit 15 during the deceleration assistance. A deceleration gradient corresponds to a rate of reduction in target deceleration of deceleration assistance with time.

The deceleration gradient setting unit 16 sets a deceleration gradient in stopping deceleration assistance based on at least one of presence or absence of a forward obstacle ahead of the host vehicle, a relative state between the host vehicle and the forward obstacle, and a road environment in which the host vehicle travels.

Forward obstacles are obstacles present ahead of the host vehicle. Forward obstacles include another vehicle traveling ahead of the host vehicle. Another vehicle may be a preceding vehicle, an oncoming vehicle, or a vehicle that crosses in front of the host vehicle. Forward obstacles may include a bicycle and a pedestrian and may include a fallen object and a structure. The deceleration gradient setting unit 16 determines whether a forward obstacle is present, based on information detected by the external sensor 1.

Forward obstacles do not need to overlap the range of deceleration objects. As for forward obstacles, for example, deceleration objects do not need to include a bicycle or a pedestrian or may include a bicycle and a pedestrian. Forward obstacles do not include a curve, a traffic light, a stop line, or the like. A relative state between the host vehicle and a forward obstacle include a distance between the host vehicle and the forward obstacle or a time to collision of the host vehicle to the forward obstacle.

A road environment in which the host vehicle travels may include, for example, whether the road is a downhill or an uphill, and may include, for example, whether the road is a curve or a straight road. A downhill is, for example, a road section of which the downward gradient is greater than or equal to a downhill threshold. An uphill is, for example, a road section of which the upward gradient is greater than or equal to an uphill threshold. A curve is, for example, a road section of which the curvature is greater than or equal to a curve threshold. A straight road is, for example, a road section of which the curvature is less than the curve threshold.

The deceleration gradient setting unit 16 sets the deceleration gradient to a steeper gradient when, for example, no forward obstacle is present at the time of a brake operation of the driver as compared to when a forward obstacle is present at the time of the brake operation. The deceleration gradient setting unit 16 detects presence of a forward obstacle based on information detected by the external sensor 1. When the distance between a forward obstacle and the host vehicle is longer than or equal to a detection distance threshold, the deceleration gradient setting unit 16 may determine that no forward obstacle is detected.

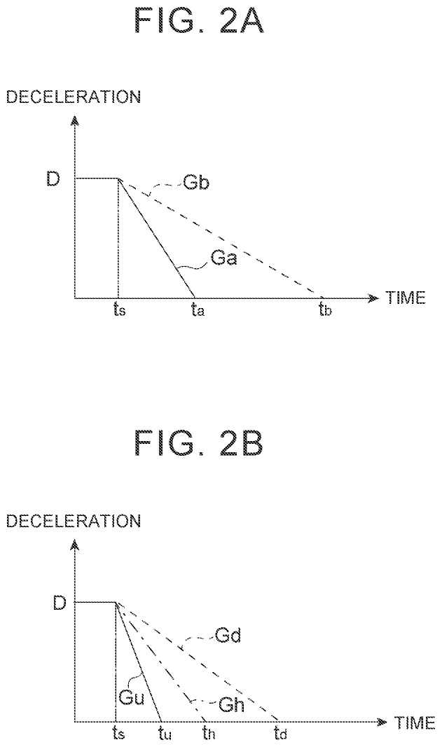

FIG. 2A is a graph showing an example of a change in deceleration gradient according to presence or absence of a forward obstacle. In FIG. 2A, the ordinate axis represents deceleration (target deceleration that is a controlled target of deceleration assistance), and the abscissa axis represents time. FIG. 2A shows a first deceleration gradient Ga and a second deceleration gradient Gb. The first deceleration gradient Ga is a deceleration gradient when no forward obstacle is present at the time of a brake operation. The second deceleration gradient Gb is a deceleration gradient when a forward obstacle is present at the time of a brake operation.

In FIG. 2A, D is a deceleration during execution of deceleration assistance (deceleration before a deceleration gradient is set in response to a brake operation of the driver), is is time at which the process of stopping deceleration assistance using the deceleration gradient is started in response to a brake operation of the driver, ta is time at which deceleration assistance stops according to the first deceleration gradient Ga, and tb is time at which deceleration assistance stops according to the second deceleration gradient Gb.

As shown in FIG. 2A, the first deceleration gradient Ga that is used when no forward obstacle is present at the time of a brake operation is set to a steeper gradient as compared to the second deceleration gradient Gb that is used when a forward obstacle is present at the time of a brake operation. A steeper gradient means that the deceleration caused by deceleration assistance reduces in a shorter time than the other. The stop time ta of deceleration assistance according to the first deceleration gradient Ga is earlier than the stop time tb of deceleration assistance according to the second deceleration gradient Gb.

The first deceleration gradient Ga and the second deceleration gradient Gb do not need to be a constant gradient and may be a gradient that varies with time. In this case, the first deceleration gradient Ga just needs to be steeper in average than the second deceleration gradient Gb.

When a forward obstacle is present at the time of a brake operation of the driver, the deceleration gradient setting unit 16 may set the deceleration gradient to a gentler gradient (second deceleration gradient Gb) as the distance between the host vehicle and the forward obstacle at the time of the brake operation becomes shorter. When the distance between the host vehicle and the forward obstacle is short, deceleration assistance can be started again, so the deceleration gradient is set to a gentler gradient. The deceleration gradient setting unit 16 may use a time to collision of the host vehicle to the forward obstacle at the time of the brake operation instead of the distance between the host vehicle and the forward obstacle or may use a time headway of the host vehicle to the forward obstacle at the time of the brake operation instead of the distance between the host vehicle and the forward obstacle.

When the road environment in which the host vehicle travels at the time of a brake operation of the driver is an uphill, the deceleration gradient setting unit 16 may set the deceleration gradient to a steeper gradient as compared to when the road environment in which the host vehicle travels at the time of the brake operation is a downhill.

The deceleration gradient setting unit 16 recognizes the gradient of a road on which the host vehicle travels based on, for example, information detected by the acceleration sensor included in the internal sensor 2 of the host vehicle. The deceleration gradient setting unit 16 may recognize the gradient of a road on which the host vehicle travels by using information about the location of the host vehicle, recognized by the global navigation satellite system (GNSS), and map information containing information about the gradients of roads. When the gradient of a road is greater than or equal to an uphill threshold to an upward side, the deceleration gradient setting unit 16 determines that the road environment in which the host vehicle travels is an uphill. When the gradient of a road is greater than or equal to a downhill threshold to a downward side, the deceleration gradient setting unit 16 determines that the road environment in which the host vehicle travels is a downhill. When the gradient of a road is less than the uphill threshold to the upward side and less than the downhill threshold to the downward side, the deceleration gradient setting unit 16 determines that the road environment in which the host vehicle travels is flat.

FIG. 2B is a graph showing an example of a change in deceleration gradient according to a road environment in which the host vehicle travels. The ordinate axis and abscissa axis of FIG. 2B are the same as those of FIG. 2A. FIG. 2B shows a third deceleration gradient Gu, a fourth deceleration gradient Gd, and a fifth deceleration gradient Gh.

The third deceleration gradient Gu is a deceleration gradient in the case where the road environment in which the host vehicle travels at the time of a brake operation is an uphill. The fourth deceleration gradient Gd is a deceleration gradient in the case where the road environment in which the host vehicle travels at the time of a brake operation is a downhill. The fifth deceleration gradient Gh is a deceleration gradient in the case where the road environment in which the host vehicle travels at the time of a brake operation is flat. In FIG. 2B, tu is time at which deceleration assistance stops according to the third deceleration gradient Gu, td is time at which deceleration assistance stops according to the fourth deceleration gradient Gd, and th is time at which deceleration assistance stops according to the fifth deceleration gradient Gh.

As shown in FIG. 2B, the third deceleration gradient Gu in the case where the road environment is an uphill is set to a steeper gradient as compared to the fourth deceleration gradient Gd in the case where the road environment is a downhill. The stop time tu of deceleration assistance according to the third deceleration gradient Gu is earlier than the stop time td of deceleration assistance according to the fourth deceleration gradient Gd. The fifth deceleration gradient Gh in the case where the road environment is flat is set to a gentler gradient as compared to the third deceleration gradient Gu and a steeper gradient as compared to the fourth deceleration gradient Gd. The stop time th of deceleration assistance according to the fifth deceleration gradient Gh is located between the stop time tu of the third deceleration gradient Gu and the stop time td of the fourth deceleration gradient Gd. Thus, the driving assistance system 100 is able to set a deceleration gradient according to the gradient of a road.

The third deceleration gradient Gu, the fourth deceleration gradient Gd, and the fifth deceleration gradient Gh do not need to be a constant gradient and may be a gradient that varies with time. In this case, the third deceleration gradient Gu just needs to be steeper in average than the fourth deceleration gradient Gd.

When the road environment in which the host vehicle travels at the time of a brake operation of the driver is a curve, the deceleration gradient setting unit 16 may set the deceleration gradient to a gentler gradient as compared to when the road environment in which the host vehicle travels at the time of a brake operation is a straight road.

The deceleration gradient setting unit 16 recognizes the curvature of a road on which the host vehicle travels based on, for example, an image ahead of the host vehicle, captured by the camera included in the external sensor 1 of the host vehicle. The deceleration gradient setting unit 16 may recognize the curvature of a road on which the host vehicle travels by using information about the location of the host vehicle, recognized by the GNSS, and map information containing information about the curvatures of roads. The deceleration gradient setting unit 16 is able to, for example, set the fourth deceleration gradient Gd of FIG. 2B as the deceleration gradient in the case where the road environment is a curve and set the fifth deceleration gradient Gh of FIG. 2B as the deceleration gradient in the case where the road environment is a straight road. Thus, the driving assistance system 100 is capable of moderating a change of a vehicle behavior in stopping deceleration assistance while travelling in a curve.

When a brake operation of the driver is detected by the brake operation detection unit 15 during deceleration assistance, the deceleration assistance stop unit 17 stops deceleration assistance of the host vehicle along the deceleration gradient set by the deceleration gradient setting unit 16. The deceleration assistance stop unit 17 stops deceleration assistance of the host vehicle along the deceleration gradient by transmitting a control signal to the actuator 4 and controlling braking force with the brake actuator. When the driver is not continuing the brake operation, the deceleration of the host vehicle reduces according to the deceleration gradient.

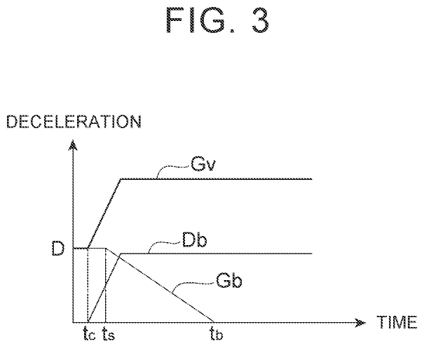

When the driver is continuing a brake operation, the deceleration assistance stop unit 17 may preferentially incorporate the brake operation of the driver into a change in the deceleration of the host vehicle. FIG. 3 is a graph showing an example of a change in the deceleration of the vehicle when a brake operation of the driver is continued in stopping deceleration assistance. In FIG. 3, the ordinate axis represents deceleration, and the abscissa axis represents time. The case where a forward obstacle is present ahead of the host vehicle will be described with reference to FIG. 3.

FIG. 3 shows the second deceleration gradient Gb, a change db in deceleration, corresponding to a brake operation of the driver, and a change Gv in the deceleration of the host vehicle. Time at which the driver starts a brake operation is denoted by tc. The change db in deceleration, corresponding to a brake operation of the driver, corresponds to a deceleration to be applied to the host vehicle as a result of the brake operation of the driver in the case where deceleration assistance is not being executed. The change Gv in the deceleration of the host vehicle is a change in deceleration to be actually applied to the host vehicle.

As shown in FIG. 3, when the driver is continuing a brake operation, the deceleration assistance stop unit 17 varies the deceleration of the host vehicle according to the brake operation of the driver with reference to the deceleration D of deceleration assistance at the time when the brake operation is started. The deceleration assistance stop unit 17 does not incorporate a deceleration gradient to the deceleration of the host vehicle while the driver is continuing a brake operation. The driver is less likely to experience a sense of discomfort because the deceleration of the host vehicle varies according to his or her own brake operation.

The deceleration assistance stop unit 17 may incorporate a reduction in deceleration according to a deceleration gradient into the deceleration of the host vehicle even when the driver is continuing a brake operation. The deceleration assistance stop unit 17 may incorporate a change in deceleration according to a brake operation of the driver and a change in deceleration according to a deceleration gradient into a change in the deceleration of the host vehicle at a selected ratio.

### Process of Driving Assistance System

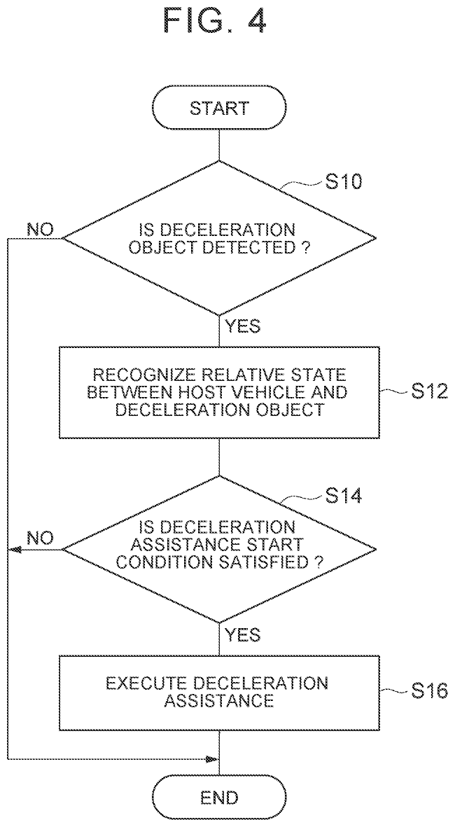

Next, the process of the driving assistance system 100 according to the present embodiment will be described with reference to the drawings. FIG. 4 is a flowchart showing an example of a deceleration assistance start process. The deceleration assistance start process is executed when a driving assistance function is active.

As shown in FIG. 4, the driving assistance ECU 10 of the driving assistance system 100 determines in S10 whether a deceleration object is detected by the deceleration object detection unit 11. The deceleration object detection unit 11 detects a deceleration object ahead of the host vehicle based on information detected by the external sensor 1. When the driving assistance ECU 10 determines that a deceleration object is detected (YES in S10), the driving assistance ECU 10 proceeds to S12. When the driving assistance ECU 10 determines that a deceleration object is not detected (NO in S10), the driving assistance ECU 10 ends the current deceleration assistance start process. After that, the driving assistance ECU 10 repeats the process from S10 again after a lapse of a certain time.

In S12, the driving assistance ECU 10 recognizes a relative state between the host vehicle and the deceleration object by using the relative state recognition unit 12. The relative state recognition unit 12 recognizes a relative state between the host vehicle and the deceleration object based on, for example, information detected by the external sensor 1.

In S14, the driving assistance ECU 10 determines whether the deceleration assistance start condition for the deceleration object is satisfied by using the start condition determination unit 13. The start condition determination unit 13 determines whether the deceleration assistance start condition is satisfied, based on the relative state between the host vehicle and the deceleration object. When the driving assistance ECU 10 determines that the deceleration assistance start condition is satisfied (YES in S14), the driving assistance ECU 10 proceeds to S16. When the driving assistance ECU 10 determines that the deceleration assistance start condition is not satisfied (NO in S14), the driving assistance ECU 10 ends the current deceleration assistance start process. After that, the driving assistance ECU 10 repeats the process from S10 again after a lapse of a certain time.

In S16, the driving assistance ECU 10 executes deceleration assistance for the deceleration object by using the deceleration assistance execution unit 14. The deceleration assistance execution unit 14 executes deceleration assistance by transmitting a control signal to the actuator 4. After that, the driving assistance ECU 10 ends the current deceleration assistance start process.

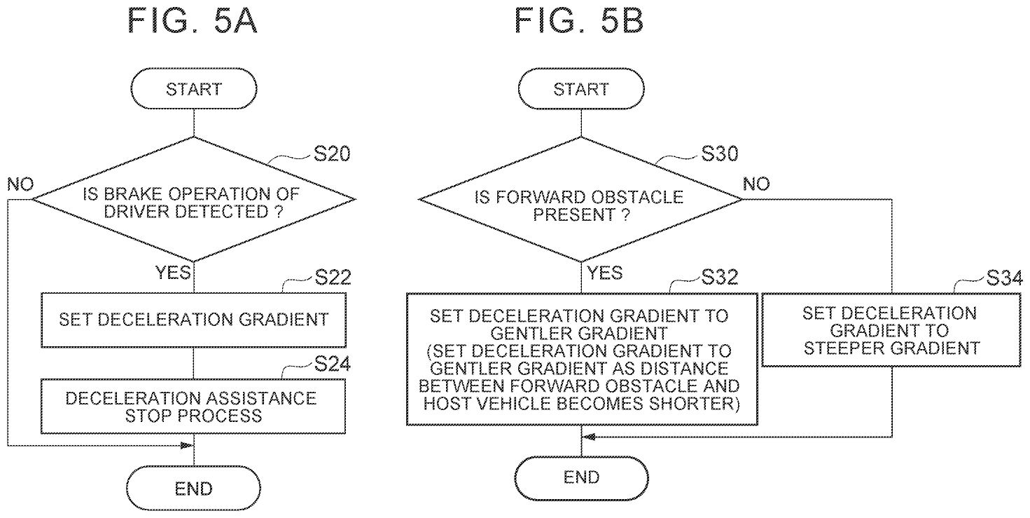

FIG. 5A is a flowchart showing an example of a deceleration assistance stop process. The deceleration assistance stop process shown in FIG. 5A is executed during execution of deceleration assistance.

As shown in FIG. 5A, the driving assistance ECU 10 determines in S20 whether a brake operation of the driver is detected by the brake operation detection unit 15. The brake operation detection unit 15 detects a brake operation of the driver based on information detected by the brake pedal sensor 3. When the driving assistance ECU 10 determines that a brake operation of the driver is detected (YES in S20), the driving assistance ECU 10 proceeds to S22. When the driving assistance ECU 10 determines that a brake operation of the driver is not detected (NO in S20), the driving assistance ECU 10 ends the current deceleration assistance stop process. After that, the driving assistance ECU 10 repeats the process from S20 again after a lapse of a certain time.

In S22, the driving assistance ECU 10 sets a deceleration gradient to be used in stopping deceleration assistance by using the deceleration gradient setting unit 16. The deceleration gradient setting unit 16 sets a deceleration gradient in stopping deceleration assistance based on at least one of presence or absence of a forward obstacle ahead of the host vehicle, a relative state between the host vehicle and the forward obstacle, and a road environment in which the host vehicle travels.

In S24, the driving assistance ECU 10 stops deceleration assistance by using the deceleration assistance stop unit 17. The deceleration assistance stop unit 17 stops deceleration assistance of the host vehicle along the deceleration gradient set by the deceleration gradient setting unit 16 by transmitting a control signal to the actuator 4 and controlling braking force with the brake actuator. After that, the driving assistance ECU 10 ends the current deceleration assistance stop process.

FIG. 5B is a flowchart showing an example of a deceleration gradient setting process. The deceleration gradient setting process corresponds to S22 of FIG. 5A.

As shown in FIG. 5B, the driving assistance ECU 10 determines in S30 whether a forward obstacle is present at the time of the brake operation by using the deceleration gradient setting unit 16. The deceleration gradient setting unit 16 determines whether a forward obstacle is present, based on information detected by the external sensor 1. When the driving assistance ECU 10 determines that a forward obstacle is present at the time of the brake operation (YES in S30), the driving assistance ECU 10 proceeds to S32. When the driving assistance ECU 10 determines that no forward obstacle is present at the time of the brake operation (NO in S30), the driving assistance ECU 10 proceeds to S34.

In S32, the driving assistance ECU 10 sets the deceleration gradient to a gentler gradient (for example, the second deceleration gradient Gb of FIG. 2A) by using the deceleration gradient setting unit 16. The deceleration gradient setting unit 16, for example, sets the deceleration gradient to a gentler gradient as the distance between the host vehicle and the forward obstacle at the time of the brake operation of the driver becomes shorter. Instead of the distance between the host vehicle and the forward obstacle, a time to collision or time headway of the host vehicle to the forward obstacle at the time of the brake operation may be used. After that, the driving assistance ECU 10 ends the current deceleration gradient setting process.

In S34, the driving assistance ECU 10 sets the deceleration gradient to a steeper gradient (for example, the first deceleration gradient Ga of FIG. 2A) by using the deceleration gradient setting unit 16. After that, the driving assistance ECU 10 ends the current deceleration gradient setting process.

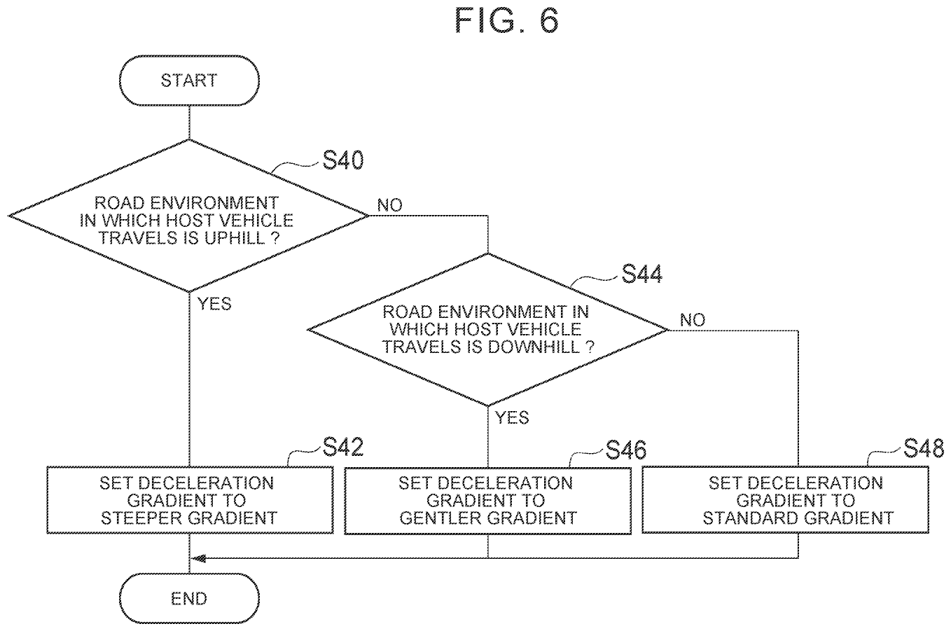

FIG. 6 is a flowchart showing another example of a deceleration gradient setting process. As shown in FIG. 6, the driving assistance ECU 10 determines in S40 whether the road environment in which the host vehicle travels at the time of the brake operation is an uphill by using the deceleration gradient setting unit 16. The deceleration gradient setting unit 16 recognizes the gradient of a road on which the host vehicle travels based on, for example, information detected by the acceleration sensor included in the internal sensor 2 of the host vehicle. When the driving assistance ECU 10 determines that the road environment in which the host vehicle travels is an uphill (YES in S40), the driving assistance ECU 10 proceeds to S42. When the driving assistance ECU 10 determines that the road environment in which the host vehicle travels is not an uphill (NO in S40), the driving assistance ECU 10 proceeds to S44.

In S42, the driving assistance ECU 10 sets the deceleration gradient to a steeper gradient (for example, the third deceleration gradient Gu of FIG. 2B) by using the deceleration gradient setting unit 16. After that, the driving assistance ECU 10 ends the current deceleration gradient setting process.

In S44, the driving assistance ECU 10 determines whether the road environment in which the host vehicle travels at the time of the brake operation is a downhill by using the deceleration gradient setting unit 16. When the driving assistance ECU 10 determines that the road environment in which the host vehicle travels is a downhill (YES in S44), the driving assistance ECU 10 proceeds to S46. When the driving assistance ECU 10 determines that the road environment in which the host vehicle travels is not a downhill (NO in S44), the driving assistance ECU 10 proceeds to S48.

In S46, the driving assistance ECU 10 sets the deceleration gradient to a gentler gradient (for example, the fourth deceleration gradient Gd of FIG. 2B) by using the deceleration gradient setting unit 16. After that, the driving assistance ECU 10 ends the current deceleration gradient setting process.

In S48, the driving assistance ECU 10 sets the deceleration gradient to a standard gradient (for example, the fifth deceleration gradient Gh of FIG. 2B) by using the deceleration gradient setting unit 16. After that, the driving assistance ECU 10 ends the current deceleration gradient setting process.

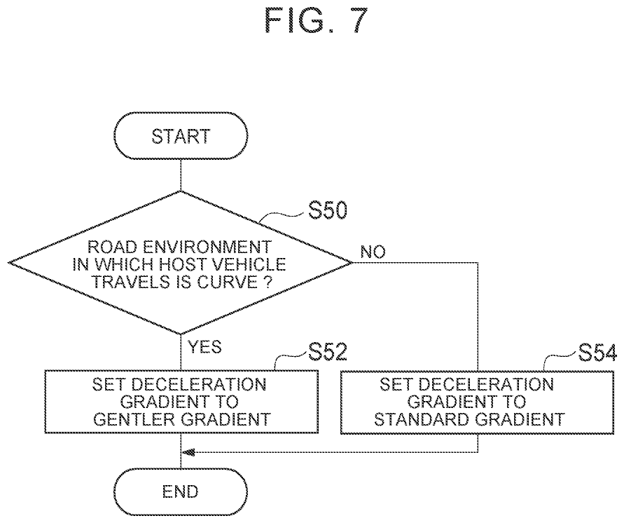

FIG. 7 is a flowchart showing further another example of a deceleration gradient setting process. As shown in FIG. 7, the driving assistance ECU 10 determines in S50 whether the road environment in which the host vehicle travels at the time of the brake operation is a curve by using the deceleration gradient setting unit 16. The deceleration gradient setting unit 16 recognizes the curvature of a road on which the host vehicle travels based on, for example, an image ahead of the host vehicle, captured by the camera included in the external sensor 1 of the host vehicle. When the driving assistance ECU 10 determines that the road environment in which the host vehicle travels is a curve (YES in S50), the driving assistance ECU 10 proceeds to S52. When the driving assistance ECU 10 determines that the road environment in which the host vehicle travels is not a curve (NO in S50), the driving assistance ECU 10 proceeds to S54.

In S52, the driving assistance ECU 10 sets the deceleration gradient to a gentler gradient (for example, the fourth deceleration gradient Gd of FIG. 2B) by using the deceleration gradient setting unit 16. After that, the driving assistance ECU 10 ends the current deceleration gradient setting process.

In S54, the driving assistance ECU 10 sets the deceleration gradient to a standard gradient (for example, the fifth deceleration gradient Gh of FIG. 2B) by using the deceleration gradient setting unit 16. After that, the driving assistance ECU 10 ends the current deceleration gradient setting process.

With the driving assistance system 100 according to the present embodiment described above, when a brake operation is performed by a driver during deceleration assistance, a deceleration gradient to stop the deceleration assistance is set based on at least one of presence or absence of a forward obstacle ahead of the host vehicle, a relative state between the host vehicle and the forward obstacle, and a road environment in which the host vehicle travels, and the deceleration assistance of the host vehicle is stopped along the set deceleration gradient. Therefore, in comparison with an existing system that stops deceleration assistance without consideration of a forward obstacle or a road environment, a sense of discomfort experienced by the driver in stopping the deceleration assistance is reduced.

With this driving assistance system 100, when no forward obstacle is present at the time of the brake operation, the deceleration gradient is set to a steeper gradient as compared to when a forward obstacle is present at the time of the brake operation. Thus, in comparison with the case where the deceleration is reduced by a gentle gradient although no forward obstacle is present, a sense of discomfort experienced by the driver is reduced.

With this driving assistance system 100, the deceleration gradient is set to a gentler gradient as a distance between the host vehicle and a forward obstacle becomes shorter or as a time to collision of the host vehicle to the forward obstacle becomes shorter. Thus, in comparison with the case where the deceleration gradient is constant regardless of a distance or time to collision between the host vehicle and the forward obstacle, a sense of discomfort experienced by the driver is reduced.

With this driving assistance system 100, when the road environment in which the host vehicle travels is an uphill, the deceleration gradient is set to a steeper gradient as compared to when the road environment is a downhill. Thus, in comparison with the case where the deceleration gradient is the same between an uphill and a downhill, a sense of discomfort experienced by the driver is reduced.

With this driving assistance system 100, when the road environment in which the host vehicle travels is a curve, the deceleration gradient is set to a gentler gradient as compared to when the road environment is a straight road. Thus, a sudden change in vehicle deceleration while traveling in a curve is reduced, which contributes to running stability.

The embodiment of the disclosure is described above; however, the disclosure is not limited to the above-described embodiment. The disclosure may be implemented in not only the above-described embodiment but also various modes with various changes or improvements based on the knowledge of persons skilled in the art.

The deceleration gradient setting unit 16 may use only a forward obstacle in setting a deceleration gradient or may use only a road environment in setting a deceleration gradient. At least one of an uphill, a downhill, and a curve may be recognized as a road environment. The deceleration gradient setting unit 16 does not necessarily need to recognize the case where a road is flat. Even when a forward obstacle is recognized, the deceleration gradient setting unit 16 does not necessarily need to set a deceleration gradient according to a relative state between the host vehicle and the forward obstacle.

The deceleration gradient setting unit 16 may adjust a deceleration gradient based on a plurality of factors. In the case where no forward obstacle is present at the time of a brake operation, when the road environment in which the host vehicle travels is an uphill, the deceleration gradient setting unit 16 may set (adjust) the deceleration gradient to a steeper gradient as compared to when the road environment in which the host vehicle travels is a downhill. In the case where no forward obstacle is present at the time of a brake operation, when the road environment in which the host vehicle travels is a straight road, the deceleration gradient setting unit 16 may set (adjust) the deceleration gradient to a steeper gradient as compared to when the road environment in which the host vehicle travels is a curve. This also similarly applies to the case where a forward obstacle is present at the time of a brake operation.

When the road environment in which the host vehicle travels at the time of a brake operation of the driver is an uphill curve, the deceleration gradient setting unit 16 may set (adjust) the deceleration gradient to a gentler gradient as compared to when the road environment is a straight road uphill. This also applies to the case of a downhill.

What is claimed is:

1. A driving assistance system that executes deceleration assistance of a host vehicle when a relative state between the host vehicle and a deceleration object ahead of the host vehicle satisfies a preset deceleration assistance start condition, the driving assistance system comprising:
a brake operation detection unit configured to detect whether a brake operation is performed by a driver of the host vehicle during the deceleration assistance;
a deceleration gradient setting unit configured to, when a brake operation is performed by the driver during the deceleration assistance, set a deceleration gradient to stop the deceleration assistance based on at least one of presence or absence of a forward obstacle ahead of the host vehicle, a relative state between the host vehicle and the forward obstacle, and a road environment in which the host vehicle travels; and
a deceleration assistance stop unit configured to, when a brake operation is performed by the driver during the deceleration assistance, stop the deceleration assistance of the host vehicle along the deceleration gradient set by the deceleration gradient setting unit.

2. The driving assistance system according to claim 1, wherein the deceleration gradient setting unit is configured to, when the forward obstacle is not present at the time of the brake operation, set the deceleration gradient to a steeper gradient as compared to when the forward obstacle is present at the time of the brake operation.

3. The driving assistance system according to claim 2, wherein the deceleration gradient setting unit is configured to, when the forward obstacle is present at the time of the brake operation, set the deceleration gradient to a gentler gradient as a distance between the host vehicle and the forward obstacle at the time of the brake operation becomes shorter or a time to collision of the host vehicle to the forward obstacle at the time of the brake operation becomes shorter.

4. The driving assistance system according to claim 1, wherein the deceleration gradient setting unit is configured to, when the road environment in which the host vehicle travels is an uphill, set the deceleration gradient to a steeper gradient as compared to when the road environment in which the host vehicle travels is a downhill.

5. The driving assistance system according to claim 1, wherein the deceleration gradient setting unit is configured to, when the road environment in which the host vehicle travels is a curve, set the deceleration gradient to a gentler gradient as compared to when the road environment in which the host vehicle travels is a straight road.
